(19) United States
(12) Patent Application Publication
(10) Pub. No.: US 2016/0186857 A1
(43) Pub. Date: Jun. 30, 2016

(54) METHOD OF CONTROLLING MACHINES WITH CONTINUOUSLY VARIABLE TRANSMISSION

(71) Applicant: Caterpillar Inc., Peoria, IL (US)

(72) Inventors: Barry Mei, Oswego, IL (US); Michael David Mitchell, Aurora, IL (US)

(73) Assignee: Caterpillar Inc., Peoria, IL (US)

(21) Appl. No.: 15/065,881

(22) Filed: Mar. 10, 2016

(51) Int. Cl. F16H 61/02; F16H 59/66; F16H 59/44

(52) U.S. Cl. CPC F16H 61/0213; F16H 59/44; F16H 59/66; F16H 2059/663

(57) ABSTRACT

A method is provided for controlling a machine having a continuously variable transmission travelling on a ground surface. The method includes receiving signals indicative of a speed of the machine and an inclination angle of the surface on which the machine is travelling. The method further includes receiving a shift signal indicative of a desired change in a direction of travel of the machine. The method selectively activates at least one supplementary retarding device based at least on one of the inclination angle and the speed of the machine.

### TECHNICAL FIELD

The present disclosure relates to controlling machines having a continuously variable transmission. More particularly, the present disclosure relates to controlling machines having a continuously variable transmission while altering a direction of travel of the machine.

### BACKGROUND

Transmission systems may be used to couple the output of a prime mover or power source, for example, an internal combustion engine, to a driven element or device such as wheels or a work implement on a work machine. Transmissions are typically part of a powertrain that transmits power that may be in the form of torque and/or rotational speed from the power source such as an engine to the driven element. A continuously variable transmission (CVT) provides an infinite or continuous range of torque-to-speed output ratios with respect to any given input from the prime mover. In other words, the output of the CVT can be increased or decreased across a continuous range in almost infinitesimally small increments.

Under certain circumstances, it may be desired to retard the machine's propulsion. For example, when the machine is travelling down an incline it may be necessary to retard the machine's propulsion in order to maintain a desired speed. In another example, during machine direction change events (e.g., forward to reverse) it is required to retard the machine's forward propulsion before propelling the machine in the reverse direction. Sometimes, the machines equipped with CVTs may not be able to provide enough powertrain retarding in a timely manner and may require additional measures to assist in slowing down the machine.

U.S. Pat. No. 3,858,696 discloses a tractor using a hydro-mechanical transmission. The tractor employs a forward-reverse drive control and applies brakes automatically in case of reversing the tractor's direction of motion.

However, controlling a machine using a CVT may substantially differ from the hydro-mechanical transmission and may pose different challenges. Hence, there is a need of a method for controlling a machine using the CVT, while altering a direction of travel of the machine.

### SUMMARY OF THE DISCLOSURE

In an aspect of the present disclosure, a method of controlling a machine having a Continuously Variable Transmission (CVT) travelling on a ground surface is provided. The method includes receiving a signal indicative of an inclination angle of the ground surface. The method also includes receiving a signal indicative of a speed of the machine. The method further includes receiving a shift signal indicative of a command for a change in a direction of travel of the machine. Subsequently, the method selectively activates at least one supplementary retarding device, through a controller, based on at least one of the speed of the machine and the inclination angle of the ground surface on which the machine is travelling.

### BRIEF DESCRIPTION OF THE DRAWINGS

FIG. 1 is a side view of an exemplary machine having a Continuously Variable Transmission (CVT) in accordance with an embodiment of the disclosure;

FIG. 2 is a schematic representation of a control system for the machine having an electric drive CVT in accordance with an embodiment of the disclosure; and

FIG. 3 is a flow chart illustrating a method of controlling the machine in accordance with an embodiment of the disclosure.

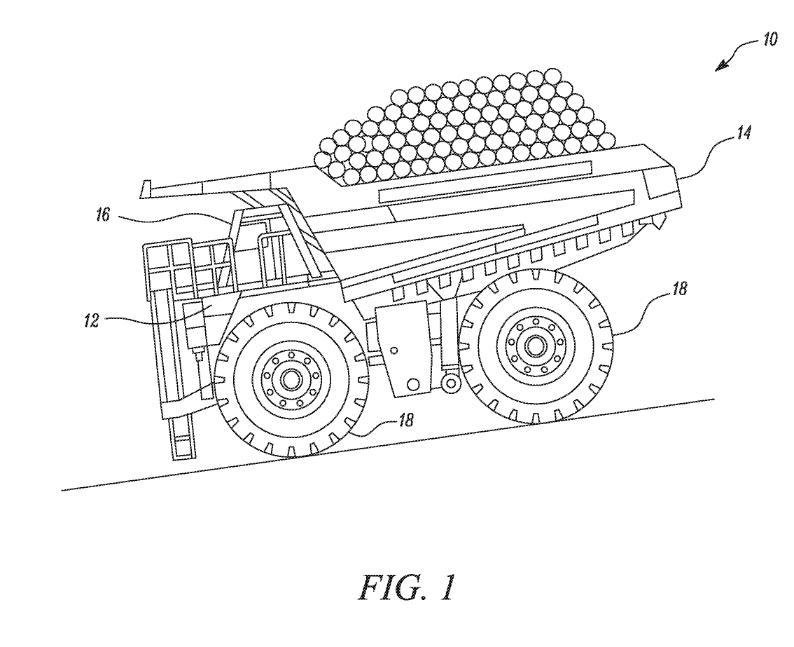

### DETAILED DESCRIPTION

Wherever possible, the same reference numbers will be used throughout the drawings to refer to same or like parts. Referring to FIG. 1, an exemplary machine 10 is illustrated. In the illustrated embodiment, the machine 10 is a load hauling truck. However, the machine 10 may be any other type of machine, for example, an articulated truck, a dozer, an excavator, a loader, and the like. The machine 10 includes a frame 12, and a dump body 14 pivotally mounted to the frame 12. The machine 10 further includes an operator cab 16 mounted on a front end of the frame 12 above an engine enclosure. The operator cab 16 may include an operator control system having a user interface. The user interface may include one or more displays, one or more user input devices, an audio device, one or more buttons, and the like. The machine 10 is supported on the ground by a pair of traction devices, such as wheels 18. The machine 10 further includes an engine housed within the engine enclosure. The engine is used to provide power to a final drive assembly, and may include a Continuous Variable Transmission (CVT). The final drive assembly may power the wheels 18.

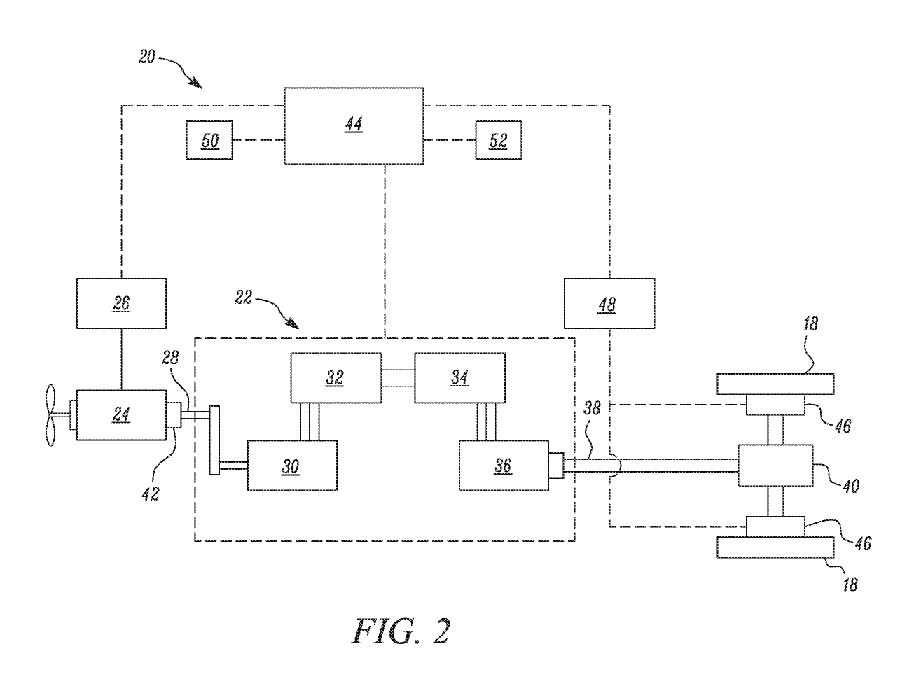

Referring now to FIG. 2, a control system 20 for the machine 10 having a CVT system 22 is shown. The transmission system 22 may be an electric drive propulsion/retarding system having a CVT output. The transmission system 22 may include: an engine 24 controlled by an engine control unit 26 and having an engine shaft 28; an electric generator 30; a generator-side power inverter 32; a motor-side power inverter 34; an electric motor 36 having a motor shaft 38; a gear drive 40: and the traction devices 18. These components 18-40 of the transmission system 22 are operatively coupled to provide power so as to propel the machine 10 during a propulsion phase of operation and to dissipate power so as to retard the machine 10 during a retarding phase of operation.

The engine 24 may be of any conventional type. For example, the engine 24 may be a diesel, gasoline, or natural gas driven internal combustion engine. During the propulsion phase, the engine 24 may combust fuel to rotate the engine shaft 28. During the retarding phase, the engine shaft 28 may be driven by the electric generator 30 (then acting as a motor). When driven in this manner, the engine 24 may dissipate undesired power through engine friction, exhaust restrictors, compression release devices, and driven accessories (e.g., pumps, etc.) of the engine 24. In addition, the engine control unit 26 may communicate data from engine sensors, such as an engine speed sensor 42 and/or other sensors (not shown). These data may provide an indication of the present dissipating potential of the engine 24. For example, the dissipating potential of the engine 24 may be associated with a non-damaging rotational speed limit of the engine shaft 28, i.e., a rotational speed that will not cause unacceptable wear on the engine 24 or its driven accessories.

The electric generator 30 may be of any appropriate type. For example, the electric generator 30 may be an AC induction, permanent magnet, AC synchronous or switched reluctance generator. During the propulsion phase, the electric generator 30 may be driven by the engine 24 to produce an alternating current. During the retarding phase, the electric generator 30 may act as a motor so as to drive the engine 24, thus dissipating undesired power in the manner discussed above. The generator-side power inverter 32 receives AC power from the electric generator 30. During the propulsion phase, the generator-side power inverter 32 may convert an AC output of the electric generator 30 to a direct current appropriate for the motor side power inverter 34. During the retarding phase, the generator-side power inverter 32 may convert a DC output of the motor-side power inverter 34 to drive the electric generator 30 (then acting as a motor) to produce a desired rotational speed of the engine shaft 28, up to a rotational speed limit of the engine 24.

The motor-side power inverter 34 may control the flow of power between the generator-side power inverter 32 and the electric motor 36. During the propulsion phase, the motor-side power inverter 34 may convert the DC output of the generator-side power inverter 32 to an alternating current appropriate to drive the electric motor 36 to produce a desired motor shaft speed and torque. During the retarding phase, the motor-side power inverter 34 may convert the AC output of the electric motor 36 (acting as a generator) to a direct current appropriate for the generator-side power inverter 32.

The electric motor 36 may be of any appropriate type. For example, the electric motor 36 may be an AC induction, permanent magnet, AC synchronous or switched reluctance motor. During the propulsion phase, the electric motor 36 may convert AC power received from the motor-side power inverter 34 to produce a desired rotational speed and torque of the motor shaft 38. During the retarding phase, the electric motor 36 may be reversible to act as a generator that may convert the non-driven rotation of the traction devices 18 into a current.

The gear drive 40 operatively couples the motor shaft 38 to the traction devices 18. The gear drive 40 may include, for example, a conventional gear reduction and/or differential. During the propulsion phase, the electric motor 36 may turn the motor shaft 38, and thus turn the gear drive 40 and the traction devices 18 so as to propel the machine 10 over the ground. During the retarding phase, the non-driven rotation of the traction devices 18 may turn the gear drive 40, and thus turn the motor shaft 38 to drive the electric motor 36 (then acting as a generator).

As explained above, the transmission system 22 may transfer power in the propulsion phase and dissipate power in the retarding phase. The transmission system 22 operates in the retarding phase when the machine 10 needs to be slowed down. Although the transmission system 22 provides retarding power to the machine 10, there is a limit to the retarding power that can be supplied based on the dissipating potential of the transmission system 22. The transmission system 22 may not be able to retard the machine 10 further than a particular limit.

To provide additional retarding capability to the machine 10, a controller 44 may select to use a supplementary retarding device such as service brakes 46. Though, only the service brakes 46 has been shown in the FIG. 2 and used as an example of supplementary retarding device, it does not limit the scope to the present disclosure. The other supplementary retarding device may include a hydraulic retarder (not shown) associated with any of the drive shafts, or transmission system 22 may lock up certain clutches (not shown) to provide the required retarding capability and other similar retarding devices. Service brakes 46 may include one or more brakes controlled by a brake control unit 48. Service brakes 46 may be of any conventional type having variable control. For example, service brakes 46 may be mechanically or hydraulically actuated by an appropriate mechanical or fluid control system, or may be in the form of a hydraulic retarder. In an embodiment, service brakes 46 may be electro-hydraulically actuated. Although service brakes 46 are illustrated as being coupled to the wheels 18, it will be understood that the number and location of service brakes 46 may be varied as known in the art.

As shown in FIG. 2, the controller 44 is communicably connected to an operator input device 50, the engine control unit 26, the transmission system 22, the brake control unit 48 and various sensors including but not limited to an inclination sensor 52 and the engine speed sensor 42. Although the controller 44 is illustrated as communicably connected to the transmission system 22 as a whole, in an embodiment, the controller 44 may also be communicably coupled to different components of the transmission system 22 such as the electric generator 30, the generator side power inverter 32, the electric motor 36, the motor side power inverter 34 etc. through separate individual controllers for the respective parts.

In an embodiment, the controller 44 may receive a shift signal indicative of a desired change in travelling direction of the machine 10. The shift signal may be based on an operator command provided through the operator input device 50. For example, in case of the machine 10 being an excavator, upon removing material from a pile and backing away from the pile, an operator of the machine 10 may manipulate and/or otherwise transition the operator input device 50 such as a forward-neutral-reverse selector associated with the machine 10 to change the travel direction of the machine 10 from reverse to forward. The controller 44 is required to initiate machine retardation in response to such a signal indicative of a change in desired travel direction. For the controller 44 to initiate the braking, the controller 44 needs to determine if the machine 10 is travelling on an inclined ground surface, a flat ground surface and a speed of the machine 10.

As shown in FIG. 2, the controller 44 is communicably coupled to the inclination sensor 52 and receives a signal indicative of inclination of the ground surface from the inclination sensor 52. The inclination sensor 52 may be coupled to the machine 10 at any suitable location on the frame 12. The inclination sensor 52 may be a three-axis accelerometer or any other type of inclination sensor suitable to current application. The inclination signal may be provided in form of a grade percentage, inclination angle and the like.

Also, the controller 44 is coupled with the engine speed sensor 42 to receive a signal indicative of an engine speed. Alternatively, the controller 44 may receive engine speed signal through the engine control unit 26 which may be communicably coupled with the engine speed sensor 42. It may be contemplated that any type of speed sensor may be used without deviating from the scope of current disclosure.

Upon receiving the shift signal, the controller 44 determines a retarding power required to stop the machine 10 for allowing a change in direction of travel of the machine 10. The controller 44 is configured to determine the retarding power based on a current mass of the machine 10, acceleration due to gravity, inclination of the surface and the speed of the machine 10. Various parameters of the machine 10 such as machine mass may be stored in a memory of the controller 44. It should be noted that the mass of the machine 10 may vary according to the extent up to which the machine 10 is loaded. Various sensors may be provided on board the machine 10 to provide a weight of the payload of the machine 10.

The controller 44 may subsequently compare the retarding power required with the maximum retarding capability of the transmission system 22 to determine whether additional retarding power is required. In an event of additional retarding power is required, the controller 44 activates service brakes 46 of the machine 10 by communicating with the brake control unit 48.

In another embodiment, the controller 44 may have look up tables stored with respect to retarding power of transmission system 22 based on various operational and non-operational parameters of the machine 10. For example, the look up tables may indicate, for a particular mass/weight of the machine 10, whether the values of grade/inclination of the ground surface and engine speed, individually, or in combination, are such that the transmission system 22 may be able to provide the required retarding torque. Upon receiving the shift signal, the controller 44 may directly compare the signals received from the inclination sensor 52 and the engine speed sensor 42 with the look up tables to determine if additional retarding power is required. Subsequently, the controller 44 may activate the service brakes 46 through the brake control unit 48 to provide the required additional retarding power.

In another embodiment, the controller 44 may notify the operator, through any means known in the art, of the machine 10 to activate the service brakes 46 if additional retarding power is required.

### INDUSTRIAL APPLICABILITY

Continuously Variable Transmissions (CVTs) typically have a limitation on the retarding capability leading to deficiencies in certain situations when high retarding power is required for a machine. One such situation is retarding power required while the machine needs to make a directional shift on a grade. When a directional shift is performed on a down grade, and the grade is above a threshold, the machine with CVT may not be able to provide enough transmission system retarding that may slow the machine down in a timely manner. If the operator does not intervene and use the service brake pedals to slow the machine down before the directional shift, the machine may continue to travel down the grade even when the machine is commanded to move in an opposite direction. A similar situation may occur on a flat ground when the directional shift is initiated at travel speeds above a threshold.

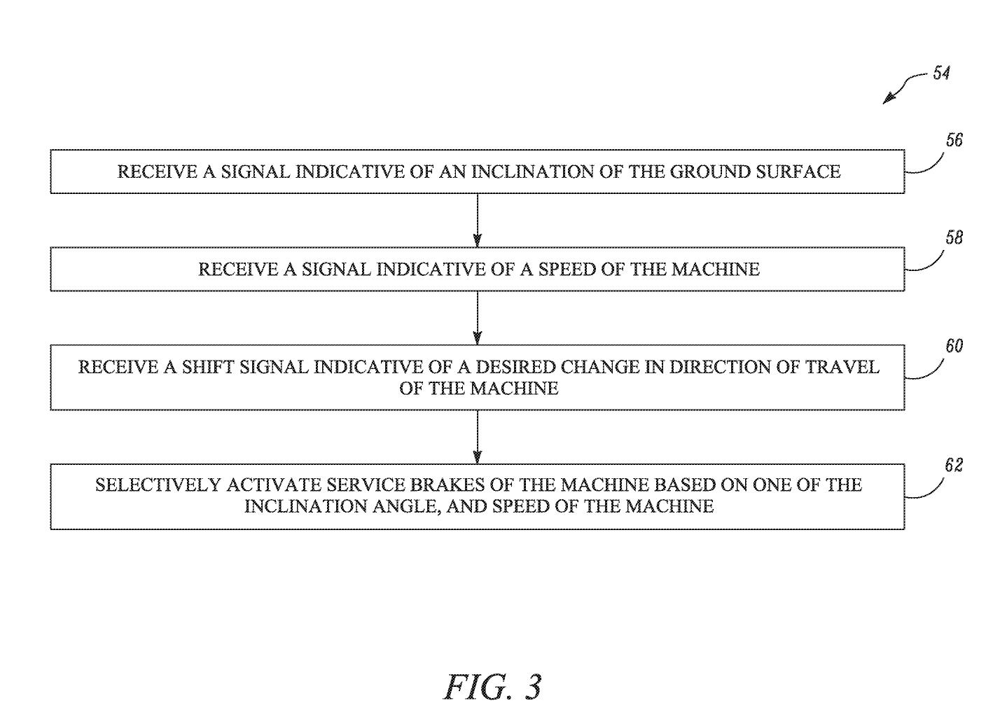

FIG. 3 illustrates a method 54 to control the machine 10 having the continuously variable transmission system 22 and travelling on a ground surface. The method 54 at step 56 receives an inclination signal indicative of the inclination of the ground surface through the inclination sensor 52. The inclination signal may be provided in form of a grade percentage, inclination angle etc.

The method 54 at step 58 receives a speed signal indicative of the speed of the machine 10 through the engine speed sensor 42. In an embodiment, a proportional-integral-derivative (PID) controller may be used to compensate any possible errors in the engine speed signal. The method 54 at step 60 receives a shift signal indicating a change in the direction of travel of the machine 10. The shift signal may be received based on an operator command to the operator input device 50.

Upon receiving the shift signal, the method 54 at step 62 selectively activates the supplementary retarding device such as service brakes 46, and may also include a hydraulic retarder associated with any of the drive shafts, or transmission system 22 may lock up certain clutches to provide the required retarding capability. The service brakes 46 of the machine 10 are activated based on at least one of the speed of the machine and the inclination angle/grade percentage of the ground surface on which the machine 10 is travelling. The method 54 may determine a retarding power required to stop the machine 10 for allowing a change in direction of travel of the machine 10. Subsequently, the method 54 may compare the retarding power required with the maximum retarding capability of the transmission system 22 to determine whether additional retarding power is required. In an event of additional retarding power is required, the method 54 activates the service brakes 46 of the machine 10 by communicating with the brake control unit 48.

In another embodiment, the method 54 may include referring to various look up tables with respect to retarding power of the transmission system 22 based on various operational and non-operational parameters of the machine 10. The look up tables may indicate whether the values of grade/inclination of the ground surface and engine speed, individually, or in combination, are such that the transmission system 22 may be able to provide the required retarding torque. Upon receiving the shift signal, the method 54 may directly compare the signals received from the inclination sensor 52 and the engine speed sensor 42 with the look up tables to determine if additional retarding power is required. Subsequently, the method 54 may activate the service brakes 46 through the brake control unit 48 to provide the required additional retarding power.

The method 54 provides operator assistance in terms of automatically activating the supplementary retarding device, upon receiving a command for a desired change in direction of travel of machine 10.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A method of controlling a machine having a continuously variable transmission, travelling on a ground surface, the method comprising:
receiving an inclination signal, through an inclination sensor, wherein the inclination signal is indicative of an inclination angle of the ground surface;
receiving a speed signal, through a speed sensor, wherein the speed signal is indicative of a speed of the machine;
receiving a shift signal, through an input device, wherein the shift signal is indicative of a command for a change in a direction of travel of the machine; and
selectively activating, through a controller and in response to receiving the shift signal, at least one supplementary retarding device based at least in part on one of the inclination angle, and the speed of the machine.
